(19) United States
(12) Patent Application Publication
(10) Pub. No.: US 2019/0107319 A1
(43) Pub. Date: Apr. 11, 2019

(54) Water Cooler with Filter

(71) Applicant: VitaFilta, Inc., Norcross, GA (US)

(72) Inventors: Gary Flaks, Alpharetta, GA (US); Delon Schermeier, Randburg (ZA)

(21) Appl. No.: 16/151,504

(22) Filed: Oct. 4, 2018

Related U.S. Application Data
(60) Provisional application No. 62/568,369, filed on Oct. 5, 2017.

(51) Int. Cl. F25D 23/12; C02F 1/00; B67D 3/00

(52) U.S. Cl. CPC F25D 23/126; B67D 3/0029; B67D 3/0009; C02F 1/003

(57) ABSTRACT

The water cooler includes a base, a lower housing supported on the base with a cooling tank therein. A tray tank is supported on the lower housing and has a draft surfaces leading to a tray tank outlet. An outer tank with a lower opening is in fluid communication with the draft surface of the tray tank. An upper opening of the outer tank supports an inner tank with the inner tank nested within the outer tank. The inner tank has a top opening for receiving water and a bottom opening with a filter. A lid covers the openings of both the outer tank and the inner tank. The cooling tank has a cooling tank inlet for receiving water from the tray tank outlet, a cooling tank outlet connected to a spigot outside of the lower housing, an air relief tube, and a cooling mechanism attached to the cooling tank to cool water therein.

### CLAIM OF PRIORITY

This application claims priority from U.S. Provisional Patent Application Ser. No. 62/568,369, filed on Oct. 5, 2017, which is incorporated herein in its entirety.

### FIELD OF THE INVENTION

This invention relates to a water cooler with a filter, and more particularly to a water cooler with an inner tank nested within an outer tank in order to maximize the amount of filtered water available for cooling.

### BACKGROUND OF THE INVENTION

In connection with a conventional water cooler, water is supplied to the user in a separate bottle with a sealed top opening. The bottle is typically opened and quickly inverted onto the water cooler. Alternatively, some water coolers have a mechanism for opening the sealed top as the bottle is inverted and placed on the water cooler. In addition, some conventional water coolers have a separate filter positioned in the water cooler between the opening of the bottle and a cooling tank within the water cooler and downstream from the bottle.

Such a prior art water coolers are shown, for example, in Flax U.S. Pat. No. 7,882,705, O'Brien U.S. Pat. No. 3,923,662, Rundle et al. U.S. Pat. No. 5,567,322, Charbonneau et al. U.S. Pat. No. 5,139,666, and Bowler United States Patent Application Publication No. 2002/0070153.

### SUMMARY OF THE INVENTION

The water cooler of the present invention includes a base, a lower housing supported on the base with a cooling tank therein, a tray tank supported on the lower housing above the cooling tank, an outer tank supported above the tray tank, and an inner tank supported on an upper opening of the outer tank and nested within the outer tank. The cooling tank has a top inlet tube in liquid communication with the tray tank and an outlet delivery tube connected to a spigot for delivery of water to the user. The cooling tank has a cooling apparatus, particularly a Peltier cooler, for cooling water in the cooling tank.

The tray tank, supported on the lower housing, has an upper draft surface or surfaces that lead to a tray tank outlet that is connected to the top inlet tube of the cooling tank. The outer tank, supported on the tray tank, has a lower opening that is in fluid communication with the draft surface of the tray tank. The outer tank also has an upper opening.

The inner tank is supported by the upper opening of the outer tank and is nested within the outer tank. The inner tank has a top opening and a bottom opening. A filter is supported in the bottom opening, and the filter is positioned above the draft surface of the tray tank. A lid covers both the top opening of the inner tank and the upper opening of the outer tank.

In operation, the lid is removed and water is poured directly into the inner tank through the top opening. The water flows through the filter and onto the draft surface of the tray tank. The water then flows through the tray tank outlet, through the inlet tube of the cooling tank, and into the cooling tank. As more water is poured into the inner tank, the water backs up from the draft surface of the tray tank into the outer tank until the water level in the inner tank and the outer tank are at the same level. Consequently, all of the water in the outer tank is filtered and available for immediate supply through the tray tank to the cooling tank. The head pressure in the outer tank and inner tank force the cooled water in the cooling tank through the outlet delivery tube and to the spigot for delivery to the user.

The construction of the water cooler of the present invention with the inner tank and bottom filter nested within the outer tank provides a construction in which water is directly poured into the inner tank without the necessity of inverting a water bottle with the accompanying possibility of spillage. In addition, the nested construction assures that water poured into the inner tank flows through the filter into the tray tank, into the cooling tank, and then fills the outer tank to provide a reservoir of filtered water within the outer tank for rapid delivery to the tray tank and then to the cooling tank.

The nested construction of the inner tank in the outer tank allows easy access to both for cleaning. The lid closes the top opening of the inner tank and the upper opening of the outer tank and allows air to escape from the outer tank as the inner tank is being filled. In addition, the lid allows air into the outer tank and the inner tank as water is removed through the spigot.

Further objects, features and advantages will become apparent upon consideration of the following detailed description of the invention when taken in conjunction with the drawings and the appended claims.

### BRIEF DESCRIPTION OF THE DRAWINGS

FIG. 1 is a front perspective view of a water cooler in accordance with the present invention.

FIG. 2 is an exploded front perspective view showing the outer tank and the inner tank of the water cooler in accordance with the present invention.

FIG. 3 is a side section view of the water cooler in accordance with the present invention.

FIG. 4 is a section view of the inner tank of the water cooler in accordance with the present invention.

FIG. 5 is a section view of the tray tank of the water cooler in accordance with the present invention.

FIG. 6 is a perspective view of the lid and the outer tank of the water cooler in accordance with the present invention.

FIG. 7 is a section view of the lid, the inner tank, and the outer tank of the water cooler in accordance with the present invention.

FIG. 8 is a detailed section view of the interface between the outer tank and the inner tank of the water cooler in accordance with the present.

### DETAILED DESCRIPTION OF THE PREFERRED EMBODIMENT

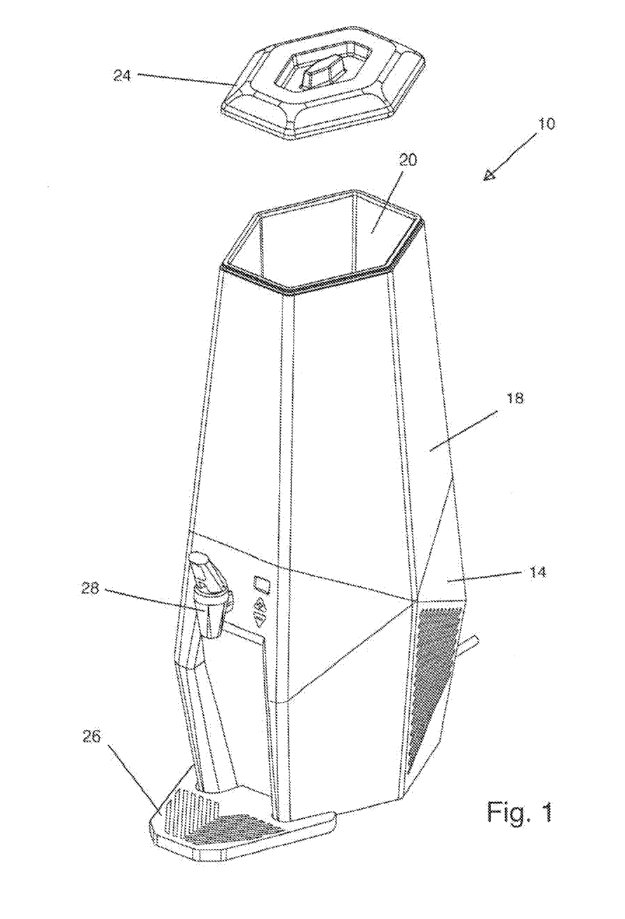

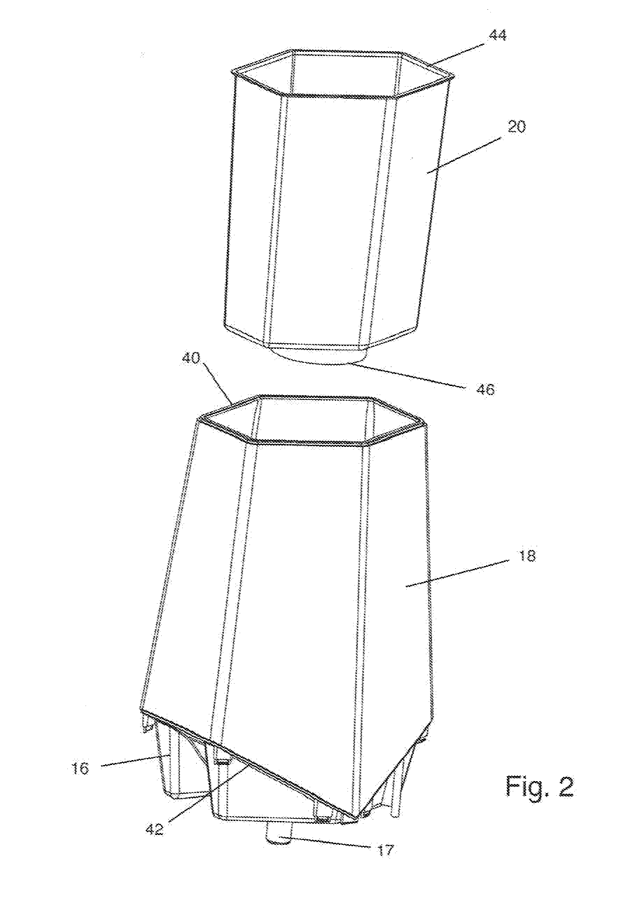

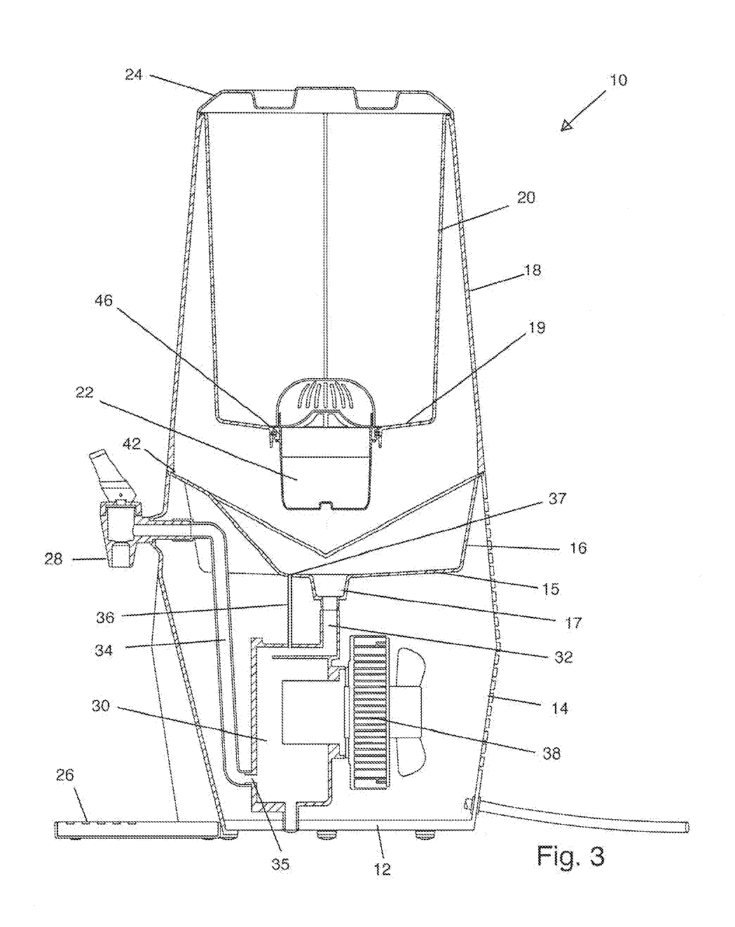

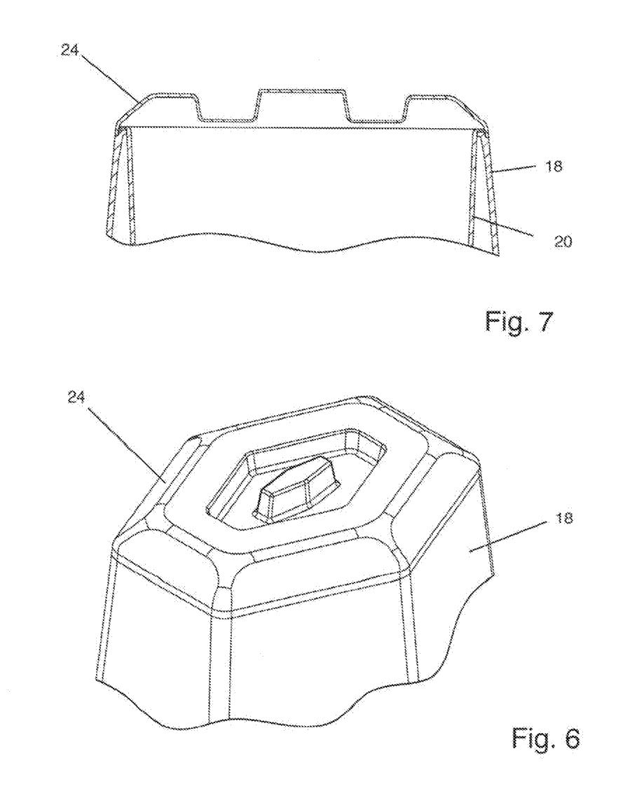

Turning to FIG. 1-8, the water cooler 10 of the present invention comprises a base 12 (FIG. 3), a lower housing 14, a tray tank 16 with a draft surface 15 (FIG. 3), an outer tank 18, and an inner tank 20. The housing 14 is supported on base 12 and encloses the internal components of the water cooler 10. With reference to FIG. 3, the internal components include a cooling tank 30 with an inlet tube 32, an outlet delivery tube 34, and a relief tube 36. A Peltier cooler 38 is attached to one side of the cooling tank 30 in order to cool the water in the cooling tank 30. The Peltier cooler 38 includes an adjustment to set the temperature of the water in the cooling tank 30. A spigot 28 is connected to the delivery tube 34 and is attached to the outside of the housing 14. A drip tray 26 is attached to the base 12 and extends outwardly below the spigot 28.

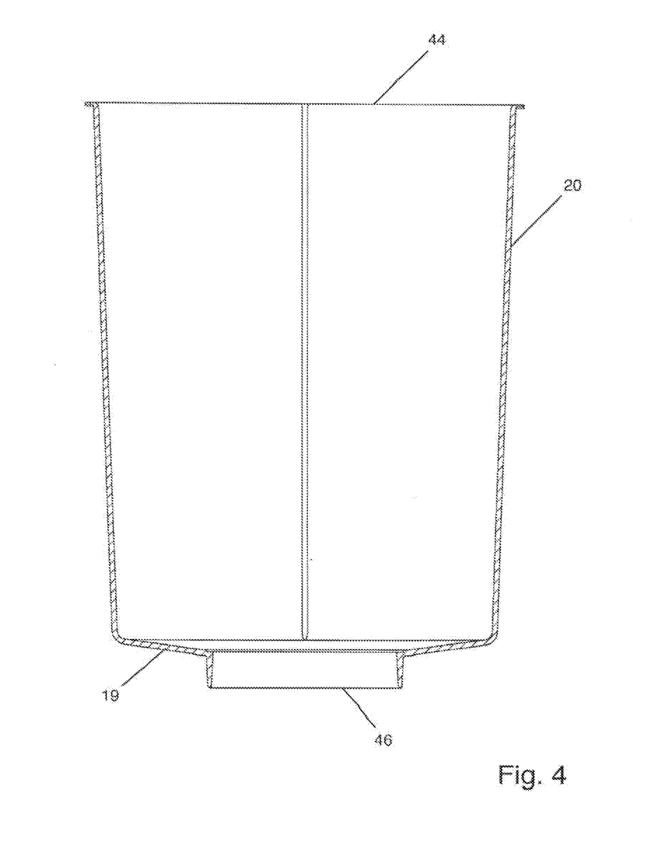

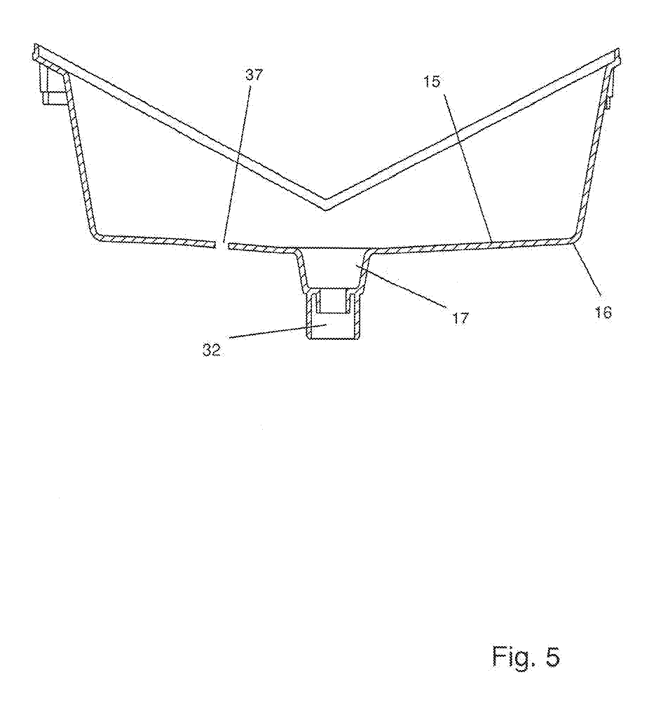

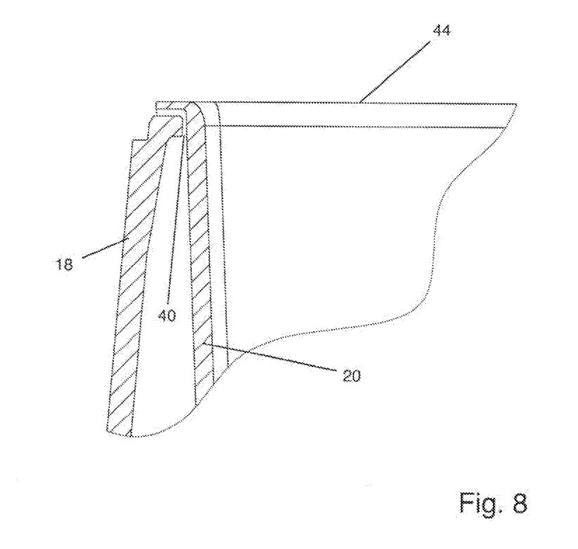

The lower housing 14 supports the tray tank 16 and the outer tank 18. The outer tank 18 has an upper opening 40 and a lower opening 42. The engagement between the edges of the tray tank 16 and the lower opening 42 of the outer tank 18 is a watertight tongue and groove joint. While the outer tank 18 and the tray tank 16 are shown as separate elements, the outer tank 18 and the tray tank 16 could be formed as a single element supported by the housing 14. The inner tank 20 has top opening 44 and is supported by the upper opening 40 of the outer tank 18 (FIG. 8). The inner tank 20 extends downward into and is nested within the outer tank 18. The bottom 19 of the inner tank 20 has a bottom opening 46 (FIG. 4) and is positioned above the draft surface 15 of the tray tank 16. A filter 22 is mounted in the opening 46 in the bottom 19 of the inner tank 20. As shown in FIG. 3, the filter 22 is positioned above the draft surface 15 of the tray tank 16. As shown in FIGS. 3 and 5, the draft surface 15 of the tray tank 16 slopes toward a bottom outlet 17. A lid 24 closes both the top opening 44 of the inner tank 20 and the upper opening 40 of the outer tank 18. The lid 24 allows air to enter the inner tank 20 and the outer tank 18 as water is drawn from the spigot 28. Further, as the outer tank 18 fills, the lid 24 allows air to escape from the outer tank 18.

The outlet 17 in the bottom of the tray tank 16 (FIGS. 3 and 5) connects to the inlet tube 32 of the cooling tank 30. The relief tube 36 connects the top of the cooling tank 30 to an opening 37 in the draft surface 15 of the tray tank 16. The outlet delivery tube 34 connects the bottom of the cooling tank 30 to the spigot 28. Particularly, the outlet delivery tube 34 includes a stub section 35 that is attached to a side portion of the cooling tank 30. The horizontal stub section 35 extends horizontally from near the bottom of the cooling tank 30. The outlet delivery tube 34 is connected to the stub section and then turns upward at a 90° angle, and connects to the spigot 28.

In operation, the lid 24 is removed from the water cooler 10 and unfiltered water is poured into the inner tank 20. The water passes through the filter 22 at the bottom 19 of the inner tank 20. From the filter, the water initially passes through the tray tank outlet 17, through the inlet tube 32, and into the cooling tank 30. As the cooling tank 30 fills, air in the cooling tank 30 escapes through relief tube 36 and through relief opening 37 in the tray tank 16. Once the cooling tank 30 is filled, the water backs up into the tray tank 16 and fills the tray tank 16 until the water level in the inner tank 20 equalizes with the water level in the outer tank 18. As more water is added to the inner tank 20, the water level in the outer tank 18 rises until the levels in the inner tank 20 and the outer tank 18 are equal.

The head of water in the outer tank 18 provides pressure for delivering water from the cooling tank 30 through the outlet delivery tube 34 and out of the spigot 28. As water is withdrawn from the cooling tank 30 through the spigot 28, additional water is delivered from the outer tank 18 into the cooling tank 30. As the level in the outer tank 18 is lowered, the water in the inner tank 20 flows through the filter 22 to equalize the water level between the inner tank 20 and the outer tank 18. As the water level in the inner tank 20 and the outer tank 18 is lowered, the lid 24 allows air into both the inner tank 20 and the outer tank 18 in order to equalize air pressure above the water.

While this invention has been described with reference to preferred embodiments thereof, it is to be understood that variations and modifications can be affected within the spirit and scope of the invention as described herein and as described in the appended claims.

I claim:

1. A water cooler comprising:
a. an outer tank including an upper opening and a lower opening;
b. an inner tank nested within the outer tank and including a top opening and a bottom opening;
c. a filter interposed between the bottom opening of the inner tank and the outer tank for filtering water passing from the inner tank into the outer tank;
d. a cooling tank for receiving water from the lower opening of the outer tank and having a cooling mechanism for cooling water in the cooling tank; and
e. a spigot for receiving water from the cooling tank and for delivering water to a user.

2. The water cooler of claim 1, wherein the water cooler includes a lid that closes the upper opening of the outer tank and the top opening of the inner tank but allows air into and out of the outer tank and the inner tank.

3. The water cooler of claim 2, wherein the water cooler further includes a tray tank interposed between the outer tank and the cooling tank for receiving water from the outer tank and discharging water to the cooling tank.

4. The water cooler of claim 3, wherein the water cooler further includes a relief tube extending between a top portion of the cooling tank and a bottom surface of the tray tank to pass air from the cooling tank into the upper tank and subsequently out of the upper tank around the lid.

5. The water cooler of claim 1, wherein the cooling mechanism is a Peltier cooler.

6. A water cooler comprising:
a. a base;
b. a lower housing supported by the base;
c. a tray tank supported by the lower housing including a draft surface leading to a tray tank outlet;
d. an outer tank supported by the tray tank including:
i. upper opening; and
ii. a lower opening in fluid communication with the draft surface of the tray tank;
e. an inner tank supported by the upper opening of the outer tank including:
i. a top opening for the introduction of water; and
ii. a bottom opening including a filter for filtering water passing from the inner tank to the outer tank;
f. a lid covering the openings of both the outer tank and the inner tank and allowing for the passage of air into and out of the inner tank and the outer tank; and
g. a cooling tank contained within the lower housing and having:
i. a cooling tank inlet for receiving water from the tray tank outlet; and
ii. a cooling tank outlet connected to a spigot outside of the lower housing; and
iii. a cooling mechanism attached to the cooling tank to cool water therein.

7. The water cooler of claim 6, wherein the water cooler further includes a relief tube extending between a top portion of the cooling tank and a bottom surface of the tray tank to pass air from the cooling tank into the upper tank and subsequently out of the upper tank around the lid.
